(19) United States
(12) Patent Application Publication
(10) Pub. No.: US 2004/0261106 A1
(43) Pub. Date: Dec. 23, 2004

(54) Interactive picture-in-picture video

(76) Inventor: Wesley O. Hoffman, Los Gatos, CA (US)

Correspondence Address: Jay Sandvos, Bromberg & Sunstein LLP, 125 Summer Street, Boston, MA, 02110-1618, US

(21) Appl. No.: 10/865,557

(22) Filed: Jun. 10, 2004

Related U.S. Application Data
(60) Provisional application No. 60/479,826, filed on Jun. 19, 2003.

(51) Int. Cl. G06F 3/00; H04N 5/445; G06F 13/00; H04N 7/00; H04N 11/00; H04N 7/14

(52) U.S. Cl. 725/43; 348/563; 348/14.07

(57) ABSTRACT

An interactive picture-in-picture system and methods for distributing television information signals. A display device located at a subscriber site is divided into two viewing areas, one showing interactive television information signals received from a first tuner and one showing television information signals received from a second tuner. A user at the subscriber site can interact with the signals by using an input device. The input device sends data that is defined in relation to the displayed signals to an interactive control node. The interactive control node responds with data that causes one or both of the tuners to select a different television information signal for display. The tuners select the different signal based on the data sent by the interactive control node, causing at least one of the viewing areas to change, or continue to display the current signal if no data sent to them from the interactive control node.

This application claims priority from provisional application 60/479,826, filed Jun. 19, 2003, and incorporated herein by reference.

### TECHNICAL FIELD AND BACKGROUND ART

The present invention relates to video distribution systems, particularly those that allow for two-way communication by a user.

A picture-in-picture (PIP) video system allows a display device, such as a television, to show multiple television signals at the same time. The screen of the display device is usually divided into windows, each window showing a different signal. This can be accomplished through the use of an electronics chip, commonly known as a PIP chip. However, such a chip adds cost to a set top box, so alternate ways of implementing a PIP system have been devised. One such alternative includes storing one or more of the signals to be displayed on a memory device in the television. This stored signal is then linearly combined with the incoming television signal or signals to achieve the PIP display. However, such a system can also generate added expense, requiring that each television contain a number of potentially expensive additional components.

Interactive cable television systems have been developed that allow a user to communicate with the cable head end and the head end to communicate with the user's television. These systems can allow a user to, for example, retrieve information from the Internet related to the program the user is currently viewing. One method for doing this is known as channel hyperlinking, in which the related information is linked to the particular program currently being viewed. The information is retrieved from the Internet, or another source, and is sent to the user to replace the signal being displayed.

### SUMMARY OF THE INVENTION

Embodiments of the present invention include a method for generating an interactive picture-in-picture video display. A first interactive television signal of a television signal distribution network is displayed in a first viewing area of a display device. A subscribing user interacts with the first interactive television signal to generate a control signal. The control signal is communicated to an interactive control node of the television signal distribution network. And a second television signal of the television signal distribution network is displayed in a second viewing area of the display device, the second television signal being selected in response to an instruction from the interactive control node responsive to the control signal.

In further embodiments, the television signals include digital and/or analog television signals. The first interactive television signal may include an electronic program guide and/or may be associated with an interactive computer network web site. The second television signal may include a preview of a program associated with an interactively selected part of the first interactive television signal.

Another embodiment of the present invention includes a set top box for an interactive television signal distribution system. The box includes a first tuner for providing a first interactive television signal of a television signal distribution network for display in a first viewing area of a display device; a data transceiver for communicating a control signal to an interactive control node of the television signal distribution network, the control signal being generated responsive to user interaction with the first interactive television signal; and a second tuner for providing a second television signal of the television signal distribution network for display in a second viewing area of the display device, the second television signal being selected in response to an instruction from the interactive control node responsive to the control signal.

In further such embodiments, the television signals may include digital and/or television signals. The first interactive television signal may include an electronic program guide and/or may be associated with an interactive computer network web site. The second television signal may include a preview of a program associated with an interactively selected part of the first interactive television signal.

Embodiments of the present invention also include an interactive control node for a television signal distribution network. The node includes a television signal source for providing a plurality of television signals to a subscriber site, including at least one interactive television signal for display in a first viewing area of a display device at the subscriber site; and a controller, responsive to a control signal from the subscriber site generated responsive to user interaction with the at least one interactive television signal, for causing the television signal source to provide a second television signal for display in a second viewing area of the display device.

In a further such embodiment the plurality of television signals may include digital and/or analog television signals. The at least one interactive television signal may include an electronic program guide and/or may be associated with an interactive computer network web site. The second television signal may include a preview of a program associated with an interactively selected part of the first interactive television signal.

### BRIEF DESCRIPTION OF THE DRAWINGS

The foregoing features of the invention will be more readily understood by reference to the following detailed description, taken with reference to the accompanying drawings, in which:

FIG. 1 is an overview of an interactive picture-in-picture system.

FIG. 2 illustrates an embodiment of the system as seen from the perspective of a subscriber.

FIG. 3 illustrates an example of an electronic program guide implemented using the system.

FIG. 4 illustrates a further example of an electronic program guide implemented using the system.

FIGS. 5 and 6 illustrate an example of a subscriber interacting with the displayed signal to create a further interactive picture-in-picture display.

FIGS. 7 and 8 illustrate a further example of a subscriber interacting with the displayed signal to create a further interactive picture-in-picture display.

### DETAILED DESCRIPTION OF SPECIFIC EMBODIMENTS

As used in this description and the accompanying claims, the following terms shall have the meanings indicated, unless the context otherwise requires: “television signals” are any signals that may be utilized by a television for video display, regardless of the form, including a standard NTSC-modulated rf carrier, an MPEG-compressed digital data stream, or any other format; this includes interactive television signals.

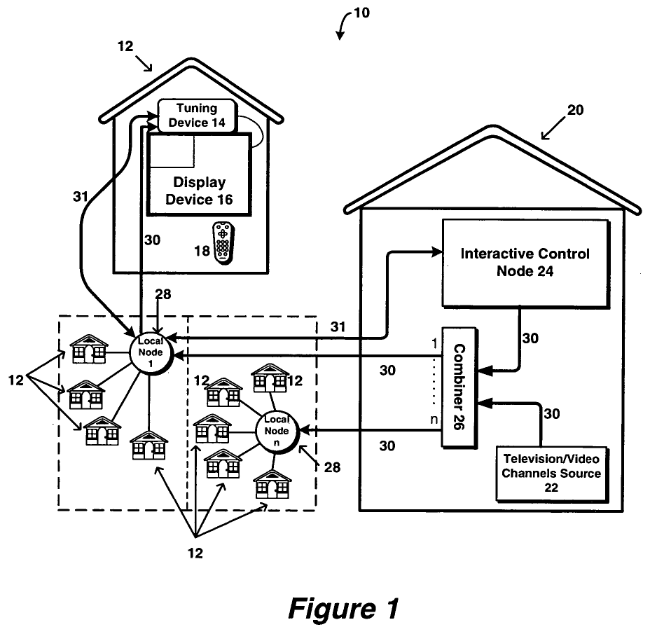

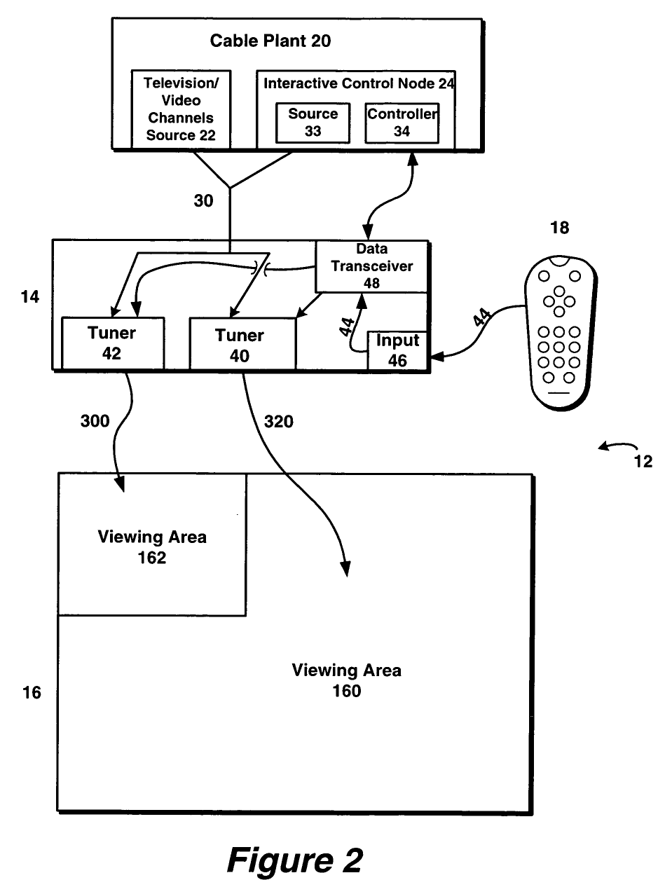

FIG. 1 shows an embodiment of an interactive picture-in-picture system 10 for use in a system for distributing television information signals. A subscriber site 12 includes a first tuner, a second tuner, a data transceiver, and an input (individual components not shown in FIG. 1, but are shown in FIG. 2 and are described below), a display device 16, and an input device 18. The first tuner, second tuner, data transceiver, and input may comprise a single unit, shown in FIG. 1 as a tuning device 14. The tuning device 14 may, thus, be a dual tuner cable set top box. The display device 16 may be a television, a screen, a monitor, or any other device that is capable of displaying television information signals. The input device 18 may be a remote control device, a keypad, a keyboard, or any other device capable of generating and transmitting signals. The input in the tuning device 14 is typically an infrared receiver responsive to an infrared remove control device. These devices are further described below in connection with FIG. 2.

The subscriber site 12 receives television information signals 30 from a signal source over a distribution system. The signal distribution system may be a cable plant 20. Other signal distribution systems, such as a satellite, may also be used. The cable plant 20 includes a television/video channels source 22, an interactive control node 24, and a combiner 26. The combiner 26 may be used to mix television information signals 30 from the interactive control node 24 and television information signals 30 from the television/video channels source 22. The mixed television information signals can then be sent over the distribution system to the subscriber site 12. The interactive control node 24 and the television/video channels source 22 may be located in different geographic areas. The interactive control node 24 is further described below, in connection with FIG. 2.

Additionally, the television information signals 30 may pass through a local node 28 located in the geographic region of the subscriber site 12. A typical system may include a plurality of television information signals 30 sent through a plurality of nodes 28 to a plurality of subscriber sites 12. Television information signals 30 may be in analog format or digital format.

An example of providing interactive television service can be shown with reference to FIG. 1. The television/video channels source 22 broadcasts television information signals 30 to the subscriber site 12. The interactive control node 24 provides interactive television information signals to the subscriber site 12. Interactive signals may be provided on a channel specifically assigned to the subscriber for the interactive session. Alternatively, the signal can be a specifically addressed digital signal that can be received and decoded by the individual subscriber. Such methods are taught in U.S. Pat. No. 6,100,883 whose full disclosure is hereby incorporated by reference herein. Other methods of providing interactive television information signals known to those of ordinary still in the arts may be used within the scope of the present invention, as well. The interactive control node 24 receives input data 31 from the subscriber site 12. The input data 31 is defined in relation to the interactive television information signal provided by the interactive control node 24 to the subscriber site 12. The interactive control node 24 then responds to the input data 31 by sending television information signal selection data to the subscriber site 12. The television information signal selection data is addressed to the subscriber site 12 so that the subscriber site 12 receives the television information signal selection data. The television information signal selection data instructs the second tuner at the subscriber site 12 to select a particular one of the television information signals for display on the display device 16. The interactive control node 24 continues to provide interactive television information signals to the subscriber site 12 throughout the process. The subscriber simultaneously views the interactive television information signal and the signal selected by the second tuner.

FIG. 2 shows an interactive picture-in-picture system from the perspective of the subscriber site 12. In FIG. 2, the display device 16 is configured to show television information signals 30. The display device 16 comprises two viewing areas, a first viewing area 160 and a second viewing area 162. The first viewing area 160 and the second viewing area 162, described throughout, may be of any size and either one may be larger than the other. A first tuner 40 and a second tuner 42 determine which of the television information signals 30 the display device 16 shows. The first tuner 40 receives interactive ones of the television information signals 30 from the interactive control node 24, and displays an interactive television information signal 320 assigned to the subscriber site in a first viewing area 160. The second tuner 42 tunes to one of the television information signals 30 from the cable plant 20, which may be a standard broadcast signal or an interactive television information signal. The second tuner 42 displays the television information signal 300 in a second viewing area 162. The television information signals 30 may be in analog or digital format.

A user or subscriber at the subscriber site 12 can interact with the television information signals shown on the display device 16 by using the input device 18. The input device 18 generates an input data signal 44. The input data signal 44 is defined in relation to the interactive television information signal 320 displayed in the first viewing area 160. The input data signal 44 is received by an input 46, which sends the input data signal 44 to a data transceiver 48. A typical input 46 would be an infrared receiver. The data transceiver 48 is in communication with the first tuner 40, the second tuner 42, and the interactive control node 24. When the data transceiver 48 receives the input data signal 44, it communicates with the interactive control node 24. In response to this communication, the interactive control node 24 sends data back to the data transceiver 48. This data may be television information signal selection data. Television information signal selection data instructs the data transceiver 48 to cause the second tuner 42 to tune to a selected one of the television information signals 30. The second viewing area 162 of display device 16 then displays this selected television information signal.

The interactive control node 24 will now be described. The interactive control node 24 contains a source 33 of interactive television information signals and a controller 34. The controller 34 is typically a processor or plurality of processors for providing an individualized television information signal to each subscriber requesting an interactive signal. Interactive television information signals are sent to the subscriber site 12 either digitally or in analog format depending upon the system. The first tuner 40 at the subscriber site 12 receives television information signals 30 and provides the assigned interactive television information signal 320 to the display device 16 for display in a viewing area 160. The controller 34 is in communication with the subscriber site 12. Input data signals 44 from the subscriber site 12 defined with respect to the interactive television information signals are sent by the receiver upstream to the interactive control node 24. The controller 34 responds to the signals. Typically, the responses relate to the interactive television information signal and involve changing the interactive television information signal. This may include a wide variety of interaction such as pausing, rewinding, fast forwarding a movie or simply making a move on a game board or operating an action figure in a video game.

In accordance with an aspect of the invention, the input data signal may be used to cause a reaction in a second viewing area 162 of the display device 16. An input data signal 44 defined with respect to the interactive television information signal 320 is sent by the viewer to the interactive control node 24. In response, the interactive control node 24 sends television information signal selection data for use by the second tuner 42. The television information signal selection data is addressed to the subscriber site 12, and identifies a television information signal to the second tuner 42. This instructs the second tuner 42 to select a certain television information signal, which is then displayed on the second viewing area 162 of the display device 16.

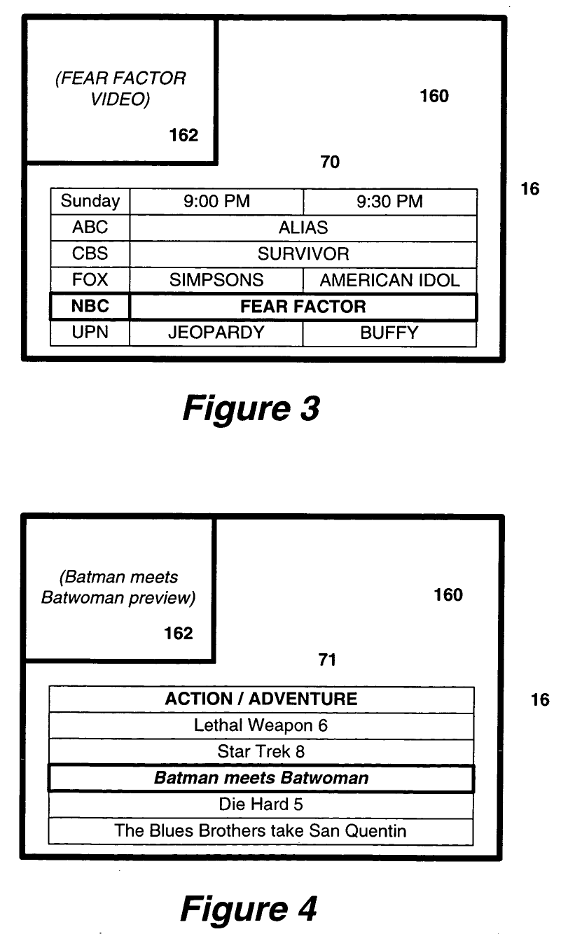

FIG. 3 illustrates an electronic program guide as part of an interactive picture-in-picture system that can be implemented according to the system shown in FIGS. 1 and 2. The display device 16 is divided into the first viewing area 160 and the second viewing area 162. The first viewing area 160 displays an interactive television information signal, here an electronic program guide 70 that is a listing of the television programs available at a certain time. The second viewing area 162 displays a television information signal, here the television program currently selected on the electronic program guide 70. The system allows for viewing available programs while simultaneously reviewing the guide listing of the available programs. For example, with the cursor on NBC the viewing area 162 can be made to display the NBC signal. If a user located at the subscriber site changes the highlighted program in the electronic program guide 70 to FOX, a different television program in the second viewing area 162 (for example, The Simpsons) will be displayed. This causes the input device to generate an input data signal that references FOX as defined in relation to the electronic program guide 70 displayed on the second viewing area 162. The interactive control node receives the input data signal from the data transceiver, and responds with data that will instruct the second tuner to select the television information signal containing the different television program (in this example, The Simpsons). The second tuner receives the data and selects the appropriate television information signal. The second viewing area 162 of the display device 16 now shows the selected television information signal. The user can now view the selected television information signal, as well as the electronic program guide 70 that the first viewing area 160 continues to display on the display device 16.

FIG. 4 shows an interactive picture-in-picture system that operates similarly to FIG. 3. In FIG. 4, the electronic program guide 71, shown in the first viewing area 160 of the display device 16, is a listing of movies available for purchase from the provider. The second viewing area 162 shows a preview of the movie currently selected in the electronic program guide 71. If a user located at the subscriber site desires to see a preview of a different movie in the list, the user can use the input device to select that movie in the electronic program guide 71. This causes the input device to generate an input data signal that as defined by the electronic program guide 71 references the highlighted movie. The interactive control node receives the input data signal from the data transceiver, and responds with television information signal selection data that will instruct the second tuner to select the television information signal containing the different movie preview. The second tuner receives the data and selects the appropriate television information signal. The second viewing area 162 of the display device 16 now shows the selected television information signal with the preview of the highlighted video. The preview may be provided on an interactive one of the television information signals. The user can now view the preview, as well as the electronic program guide 71 that the first viewing area 160 continues to display on the display device 16.

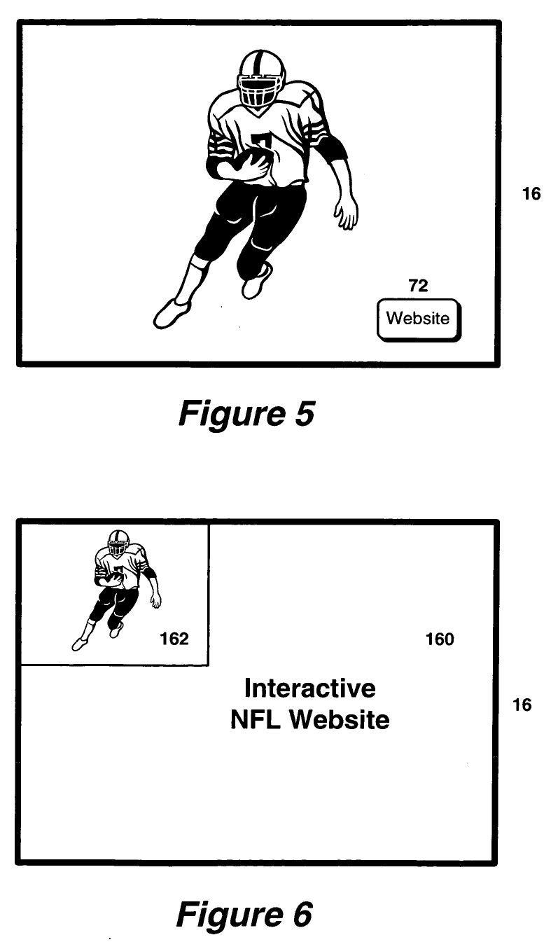

FIGS. 5 and 6 illustrate another possible implementation of the interactive picture-in-picture system. In FIG. 5, the display device 16 shows a television information signal with a superimposed interactive link 72. Link 72 could be, for example, an interactive button that causes an Internet website associated with the television information signal to be accessed. When the user interacts with the display to activate link 72, the display device 16 is divided into the first viewing area 160 and the second viewing area 162, as shown in FIG. 6. The first tuner displays the interactive television information signal in the first viewing area 160, while the second tuner is instructed to display in the second viewing area 162 the television information signal that originally occupied the entire display device 16.

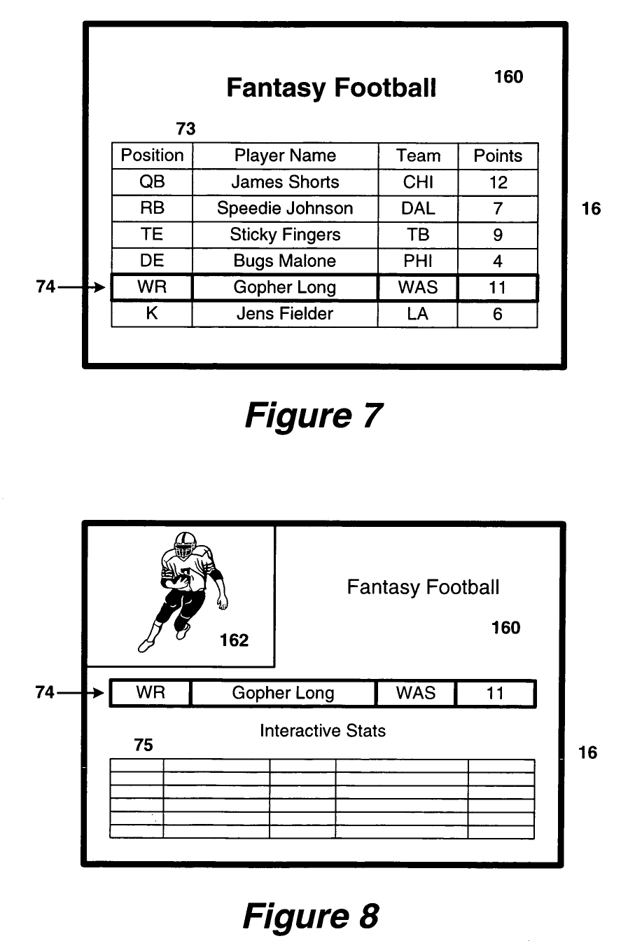

FIGS. 7 and 8 show yet another implementation of the interactive picture-in-picture system. In FIG. 7, the display device 16 displays an interactive television information signal, here depicted as a table 73 of a fantasy football team's players and their associated information. A user at the subscriber site may desire to see the video of the actual football game a particular player is participating in. To do so, the user selects a row 74 of the table 73 that contains the player's name and associated information, using the input device. The input device then generates an input data signal that is defined in relation to the interactive television information signal, shown here as the table 73 with the selected row 74. The interactive control node receives the input data signal, and responds with television information signal selection data that will instruct the second tuner to select the television information signal that contains the video of the actual football game that the selected player is participating in.

The second tuner receives the data and selects the appropriate television information signal. The display device is then divided into a first viewing area 160 and a second viewing area 162, as shown in FIG. 8. The second viewing area 162 then displays the appropriate television information signal. In this example, the data received from the interactive control node also instructs the first tuner to select a different interactive television information signal, here one that includes the selected row 74 of the table 73 with the player's name and associated information, as well as a table of the player's statistics 75. The first viewing area 160 will then display the different interactive television information signal. The user can now view the appropriate television information signal and the different interactive television information signal.

In view of the foregoing, it will therefore be understood that the scope of the invention as defined in the following claims is not limited to the embodiments described herein, and that the above and numerous additional variations and modifications could be made thereto without departing from the scope of the invention as defined in the following claims.

What is claimed is:

1. A method for generating an interactive picture-in-picture video display, the method comprising:
displaying a first interactive television signal of a television signal distribution network in a first viewing area of a display device;
interacting with the first interactive television signal to generate a control signal;
communicating the control signal to an interactive control node of the television signal distribution network; and
displaying a second television signal of the television signal distribution network in a second viewing area of the display device, the second television signal being selected in response to an instruction from the interactive control node responsive to the control signal.

2. A method according to claim 1, wherein the television signals include digital television signals.

3. A method according to claim 2, wherein the television signals include analog television signals.

4. A method according to claim 1, wherein the first interactive television signal comprises an electronic program guide.

5. A method according to claim 1, wherein the second television signal comprises a preview of a program associated with an interactively selected part of the first interactive television signal.

6. A method according to claim 1, wherein the first interactive television signal is associated with an interactive computer network web site.

7. A set top box for an interactive television signal distribution system, the box comprising:
a first tuner for providing a first interactive television signal of a television signal distribution network for display in a first viewing area of a display device;
a data transceiver for communicating a control signal to an interactive control node of the television signal distribution network, the control signal being generated responsive to user interaction with the first interactive television signal; and
a second tuner for providing a second television signal of the television signal distribution network for display in a second viewing area of the display device, the second television signal being selected in response to an instruction from the interactive control node responsive to the control signal.

8. A set top box according to claim 7, wherein the television signals include digital television signals.

9. A set top box according to claim 8, wherein the television signals include analog television signals.

10. A set top box according to claim 7, wherein the first interactive television signal comprises an electronic program guide.

11. A set top box according to claim 7, wherein the second television signal comprises a preview of a program associated with an interactively selected part of the first interactive television signal.

12. A set top box according to claim 7, wherein the first interactive television signal is associated with an interactive computer network web site.

13. An interactive control node for a television signal distribution network, the node comprising:
a television signal source for providing a plurality of television signals to a subscriber site, including at least one interactive television signal for display in a first viewing area of a display device at the subscriber site; and
a controller, responsive to a control signal from the subscriber site generated responsive to user interaction with the at least one interactive television signal, for causing the television signal source to provide a second television signal for display in a second viewing area of the display device.

14. An interactive control node according to claim 13, wherein the plurality of television signals includes digital television signals.

15. An interactive control node according to claim 14, wherein the plurality of television signals includes analog television signals.

16. An interactive control node according to claim 13, wherein the at least one interactive television signal comprises an electronic program guide.

17. An interactive control node according to claim 13, wherein the second television signal comprises a preview of a program associated with an interactively selected part of the first interactive television signal.

18. An interactive control node according to claim 13, wherein the at least one interactive television signal is associated with an interactive computer network web site.
